(19) United States
(12) Patent Application Publication
(10) Pub. No.: US 2005/0210375 A1
(43) Pub. Date: Sep. 22, 2005

(54) Apparatus, method, and program for integrating documents

(75) Inventor: Shingo Iwasaki, Yokohama-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 11/076,466

(22) Filed: Mar. 9, 2005

(30) Foreign Application Priority Data
Mar. 16, 2004 (JP) 2004-074812
Feb. 25, 2005 (JP) 2005-051777

(51) Int. Cl. G06F 17/21

(52) U.S. Cl. 715/513; 715/501.1

(57) ABSTRACT

For input structured documents, it is determined whether or not relation between the structured documents exists by comparing at least one predetermined element of each of the structured documents between the structured documents. If the relation is determined to exist, a description of each element in the structured documents that are determined to have relation therebetween is extracted. Each description extracted from the structured documents determined to have relation therebetween is integrated, thus realizing an integrated structured document.

### BACKGROUND OF THE INVENTION

1. Field of the Invention

The present invention relates to processing for a structured document.

2. Description of the Related Art

For inputting a plurality of structured documents having different structures and outputting it as a single integrated structured document, in most cases, transforming the structure of a first structured document into another structure and outputting it as a new single structured document has been performed. In other words, an input structured document is transformed into a structured document to be output in a one-to-one relationship. In addition, such a transforming and outputting process requires logical analysis of the structure of an input structured document, and this analysis processing is conducted by a human.

### SUMMARY OF THE INVENTION

The present invention provides processing of automatically integrating a plurality of structured documents having different structures into a single structured document without human intervention.

According to one aspect of the present invention, an apparatus for integrating documents includes an input device, a control device, and an output device. The input device is configured to input a plurality of structured documents. The control device is configured to determine whether relation between the structured documents exists by comparing at least one predetermined element of each of the structured documents between the structured documents and to extract a description of each element in the structured documents that are determined to have relation therebetween. The output device is configured to output an integrated structured document realized by integration of each description extracted from the structured documents determined to have relation therebetween.

In another aspect, a method for integrating documents includes an inputting step, a determining step, an extracting step, and an outputting step. In the inputting step, a plurality of structured documents is input. In the determining step, it is determined whether relation between the structured documents exists by comparing at least one predetermined element of each of the structured documents between the structured documents. In the extracting step, a description of each element in the structured documents that are determined to have relation therebetween is extracted if relation therebetween is determined to exist. In the outputting step, an integrated structured document realized by integration of each description extracted from the structured documents determined to have relation therebetween is output.

In yet another aspect, a program for integrating documents performs a method for integrating documents, the method including the following steps: an inputting step, a determining step, an extracting step, and an outputting step. In the inputting step, a plurality of structured documents is input. In the determining step, it is determined whether relation between the structured documents exists by comparing at least one predetermined element of each of the structured documents between the structured documents. In the extracting step, a description of each element in the structured documents that are determined to have relation therebetween is extracted if relation therebetween is determined to exist. In the outputting step, an integrated structured document realized by integration of each description extracted from the structured documents determined to have relation therebetween is output.

Further features and advantages of the present invention will become apparent from the following description of exemplary embodiments with reference to the attached drawings.

### BRIEF DESCRIPTION OF THE DRAWINGS

FIG. 1 shows an overall system configuration including an apparatus for integrating documents.

FIGS. 2A and 2B show details of processing in a structure transforming unit and an example of change in data.

FIGS. 3A to 3C show details of a relation analysis process in a relation-analyzing and structure-integrating unit.

FIG. 4 shows details of a structure integration process in the relation-analyzing and structure-integrating unit.

FIG. 5 shows an example of a case in which three or more extensible markup language (XML) documents are integrated into a signal XML document.

FIG. 6 shows an overall system configuration including an apparatus for integrating documents according to another embodiment.

FIGS. 7A and 7B show details of processing in a structure analyzing unit.

FIG. 8 is a block diagram showing a hardware configuration in the apparatus for integrating documents.

### DESCRIPTION OF THE EMBODIMENTS

The embodiments of the present invention are described below with reference to examples.

### First Embodiment

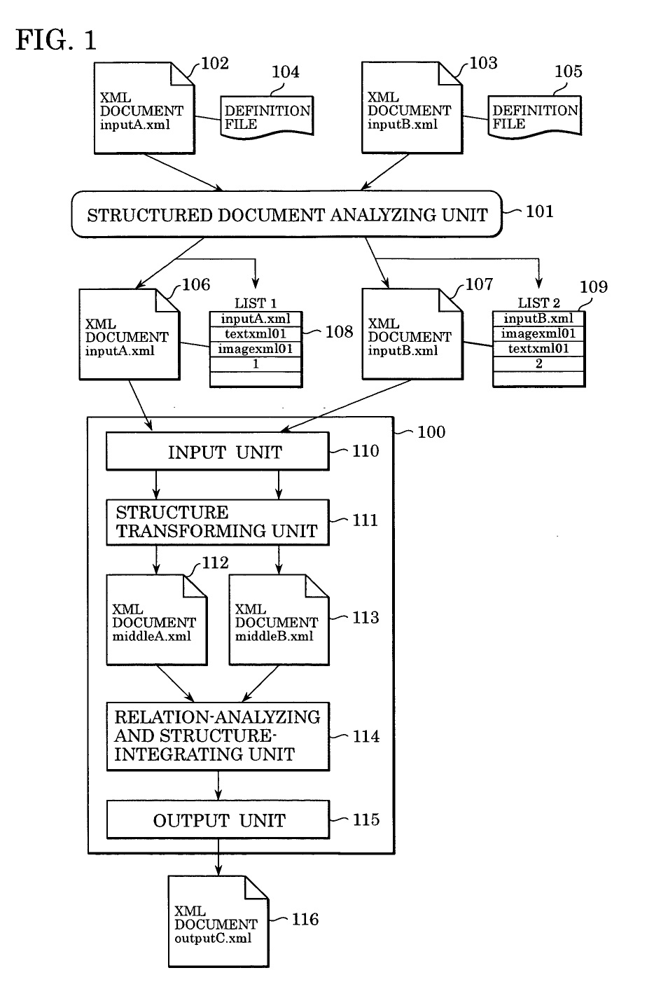

FIG. 1 shows an apparatus for integrating documents according to a first embodiment of the present invention. The flow of processing in the apparatus according to this embodiment is described below with reference to FIG. 1.

An apparatus 100 for integrating documents includes an input unit 110, a structure transforming unit 111, a relation-analyzing and structure-integrating unit 114, and an output unit 115. A structured document analyzing unit 101 is a module for analyzing a structured document, such as an XML document, and, in this embodiment, included in an external apparatus.

The structured document analyzing unit 101 receives XML documents 102 (inputA.xml) and 103 (inputB.xml) and data definition files 104 and 105, such as document type definition (DTD), or XML schema, defining the structures of the XML documents, makes lists of information used for processing for the XML documents in the apparatus 100 from the data, and outputs the lists linking with the input XML documents.

XML documents 106 and 107 are identical to the XML documents 102 and 103, respectively. Lists 108 and 109 are data prepared by the structured document analyzing unit 101 and created by classifying a predetermined element extracted from each of the XML documents into items.

The apparatus 100 receives the XML documents 106 and 107 and data of the lists 108 and 109 via the input unit 110. The structure transforming unit 111 selects XML stylesheet language transformations (XSLT) in accordance with information from the XML documents 106 and 107 and the lists 108 and 109 received via the input unit 110, deletes unnecessary information from one input XML document according to the selected XSLT, and outputs it as a single XML data. XML documents 112 and 113 are individual XML data output from the structure transforming unit 111, corresponding to the XML documents 106 and 107, respectively.

The relation-analyzing and structure-integrating unit 114 checks the relation between the input XML documents after converting individual data of the XML documents 112 and 113 to a document object model (DOM) format. The relation-analyzing and structure-integrating unit 114 then integrates the XML documents 112 and 113 that are subjected to a relation analysis process into a single XML document 116. The integrated XML document 116 (outputC.xml) is then output from the output unit 115. Each of the input unit 110 and the output unit 115 is, for example, a network interface for connecting with the Internet or an interface for the Bluetooth.

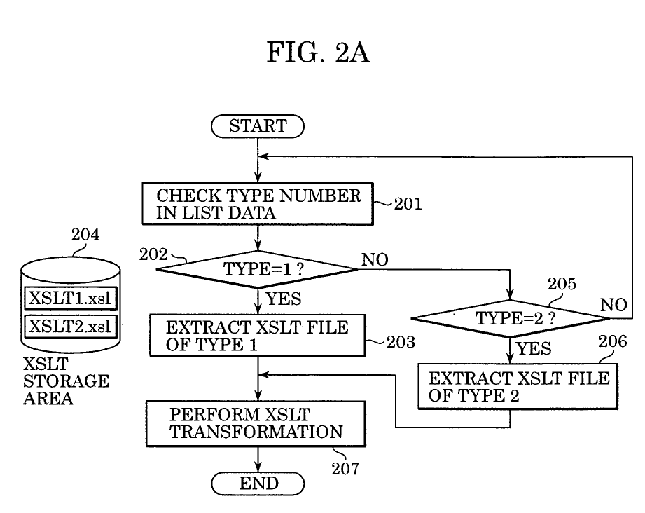

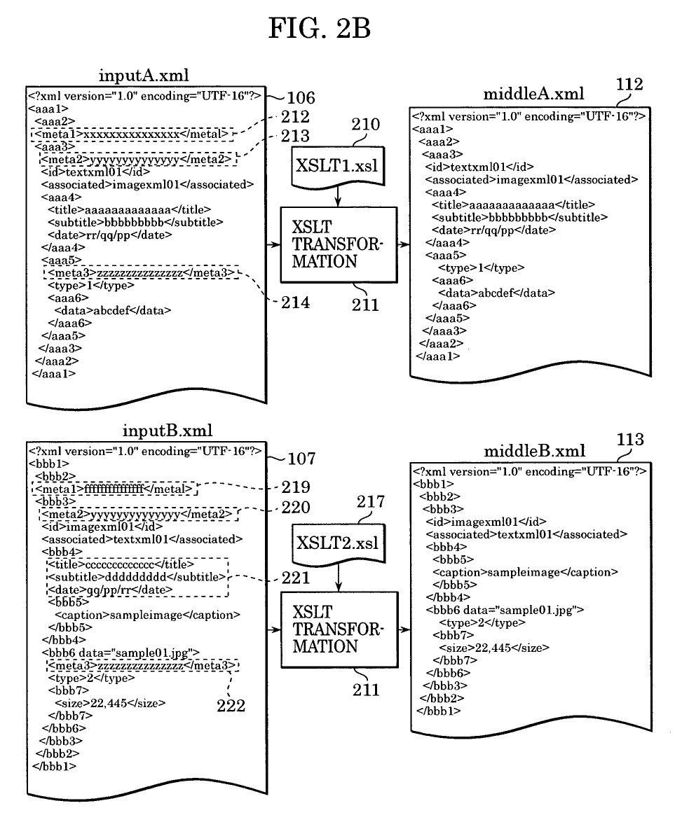

FIGS. 2A and 2B show an example of how the structure of an input XML document is changed by an XSLT transformation in the structure transforming unit 111 shown in FIG. 1 before the XML document is output.

FIG. 2A is a flowchart of processing performed by the structure transforming unit 111. In step 201, a type number of an input XML document in data of an input list is checked. In step 202, it is determined whether data of tag <type> in the input XML document is “1” or not. If the data is “1”, the processing moves to step 203.

In step 203, XSLT data (XSLT1.xsl) corresponding to a type number of 1 is extracted from data stored in advance in an XSLT storage area 204. If the type number is not “1”, the processing moves to step 205 and it is determined whether data of tag <type> is “2” or not. If the data is “2”, the processing moves to step 206 and XSLT data (XSLT2.xsl) corresponding to a type number of 2 is extracted from data stored in advance in the XSLT storage area 204.

If the type number is neither “1” nor “2”, another list data corresponding to the type number is acquired and corresponding XSLT data is selected. When the XSLT data (pattern data for transformation) is extracted (step 203 or step 206), the processing then moves to step 207 and the structure of data of the input XML document is transformed in accordance with the selected XSLT data.

FIG. 2B shows an example of how the structure of the XML document is changed in the XSLT transformation. XSLT data 210 (XSLT1.xsl) is selected data that corresponds to the XML document 106. XSLT transformation 211 is performed by the structure transforming unit 111. In the XSLT transformation 211, according to the XSLT data 210 indicating the deletion of unnecessary data from the XML document 106, unnecessary data is removed from the XML document 106.

More specifically, in the XSLT transformation 211, according to the XSLT data 210, tags <meta1> 212, <meta2> 213, and <meta3> 214 and elements thereof are removed from the XML document 106, and then the XML document 106 is output as a new XML document 112 (middleA.xml).

Similarly, in the XSLT transformation 211, which is performed within the structure transforming unit 111, according to XSLT data (XSLT2.xsl) 217, unnecessary data is removed from the XML document 107. More specifically, tags <meta1> 219, <meta2> 220, <meta3> 222, and tags <title>, <subtitle>, and <date> contained in an area 221 and elements thereof are removed from the XML document 107, and then the XML document 107 is output as a new XML document 113 (middleB.xml).

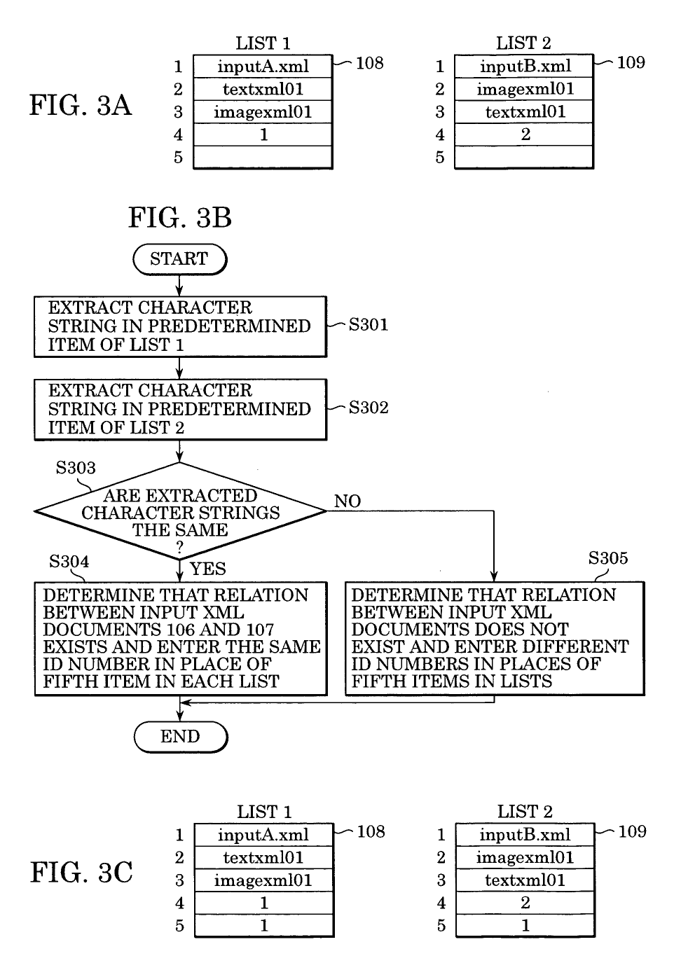

FIG. 3B shows a relation analysis process in the relation-analyzing and structure-integrating unit 114 shown in FIG. 1. The relation-analyzing and structure-integrating unit 114 checks relation between the input XML documents by using the input lists 108 and 109 (shown in FIGS. 1 and 3A).

In step S301, the relation-analyzing and structure-integrating unit 114 extracts a character string in at least one predetermined item of LIST 1 (108) shown in FIG. 3A. In this embodiment, the at least one item includes the second and third items. In step S302, the relation-analyzing and structure-integrating unit 114 extracts a character string in at least one predetermined item of LIST 2 (109) shown in FIG. 3A. In this embodiment, the at least one item includes the second and third items.

In step S303, the relation-analyzing and structure-integrating unit 114 checks whether or not the extracted character strings are the same between the lists. If the character strings are the same, the processing moves to step S304. In step S304, the relation-analyzing and structure-integrating unit 114 determines that relation between the input XML documents 106 and 107 exists and enters the same ID number in a place of the fifth item of each of the lists 108 and 109, as shown in FIG. 3C. FIG. 3C shows the lists 108 and 109 with an ID number of 1 entered in the places of the fifth items.

On the other hand, in step S303, if the character strings in each item are different, the processing moves to step S305. In step S305, the relation-analyzing and structure-integrating unit 114 determines that relation between the input XML documents does not exist and enters different ID numbers in places of the fifth items of the lists 108 and 109.

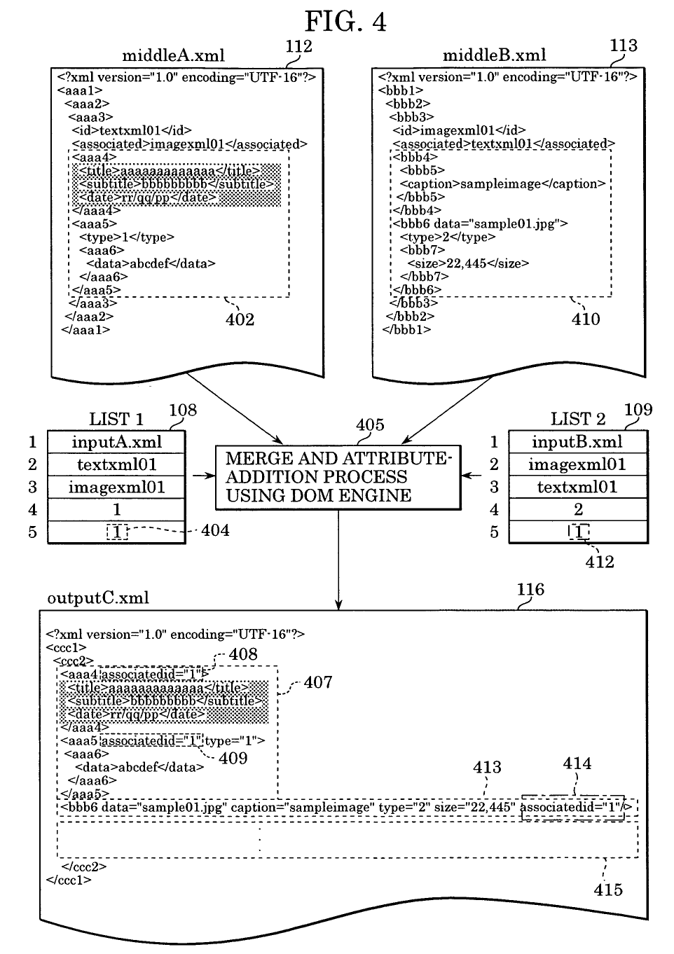

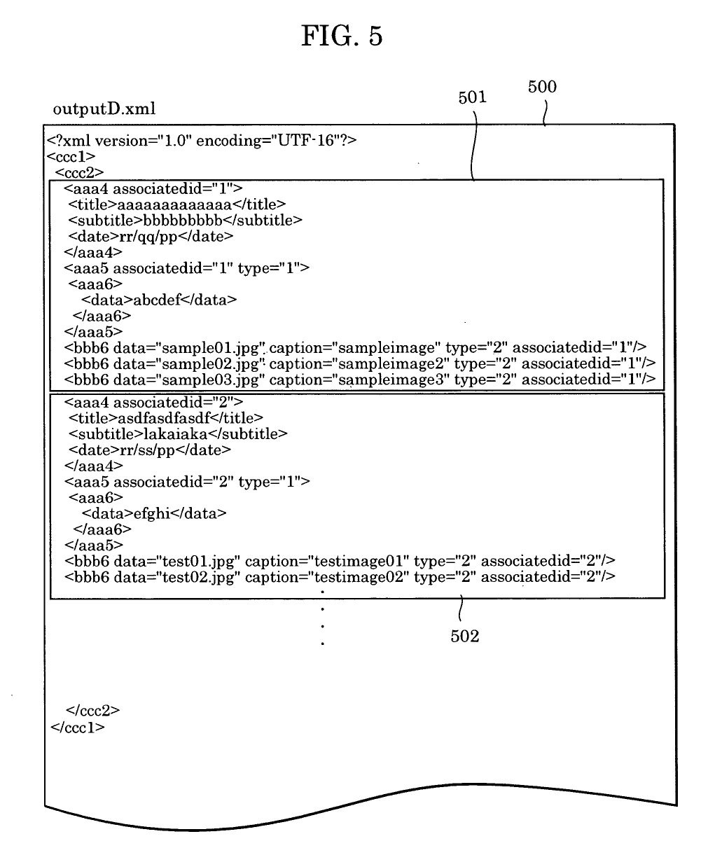

FIG. 4 shows an example of a structure integration process of integrating XML documents in the relation-analyzing and structure-integrating unit 114 shown in FIG. 1, the XML documents being output from the structure transforming unit 111 shown in FIG. 1. The XML documents 112 and 113 are documents that are output from the structure transforming unit 111.

In a merge and attribute-addition process 405 using a DOM engine included in the relation-analyzing and structure-integrating unit 114, ID numbers 404 and 412 are extracted from LISTS 1 (108) and 2 (109), respectively. If the extracted ID numbers are determined to be the same, the XML documents 112 and 113 are represented in a hierarchical structure. A merge and attribute-addition process 405 extracts each element in the XML document 112. FIG. 4 shows that a description (represented as an area 402) contained in a lower node belonging to a parent element <aaa3> for the character strings “textxm101” and “imagexm101”, which are the same as those in the XML document 113, is extracted. Similarly, a merge and attribute-addition process 405 extracts each element in the XML document 113. FIG. 4 shows that a description (represented as an area 410) contained in a lower node belonging to a parent element <bbb3> for the character strings “textxm101” and “imagexm101”, which are the same as those in the XML document 112, is extracted.

For the integration process, more specifically, in the output XML document 116, the description in the area 402 is described in an area 407, and the description in the area 410 is described in an area 413. The extracted ID number 404 is added to each extracted element in the form of “associated=1”, as represented as reference numerals 408 and 409, so as to function as an attribute. In this embodiment, the elements “<id>textxm101</id>” and “<associated>imagexm101</associated>” described in the XML document 112 and the elements “<id>imagexm101</id>” and “<associated>textxm101</associated>” described in the XML document 113 are both deleted in the integration process. However, these elements may be added as another form.

In this embodiment, two input XML documents are processed. For more than two documents, XML data is added to an area 415 in a fixed form (the form of the area 407 or the form of the area 413) specified by data of <type>, so that three or more input documents can be handled. FIG. 5 shows one such XML document integrated from three or more documents. An XML document 500 (outputD.xml) includes an area 501 containing data with an ID number of 1, an area 502 containing data with an ID number of 2, and the like. In this way, in accordance with an assigned Id number, a plurality of XML documents is integrated into a single XML document while maintaining relation therebetween.

In this first embodiment, in the process performed by the structured document analyzing unit 101 shown in FIG. 1, in the case when input XML documents include no information to be deleted and thus the structure transforming unit 111 receives a request indicating that all information is necessary, the input data is directly output to the relation-analyzing and structure-integrating unit 114 by bypassing the process of the structure transforming unit 111.

As described above, in this embodiment, the process of extracting necessary data from a plurality of input structured documents having different structures, transforming each structured document to a fragmented structure, and integrating the fragmented structure realizes the outputting of a new single structured document. Therefore, a plurality of structured documents can be output as a single integrated structured document, thus realizing the processing of various structured documents, which are now in increasing demand, in a unified architecture. In addition, even if a new structured document is input, the processing can be smoothly performed.

### Another Embodiment

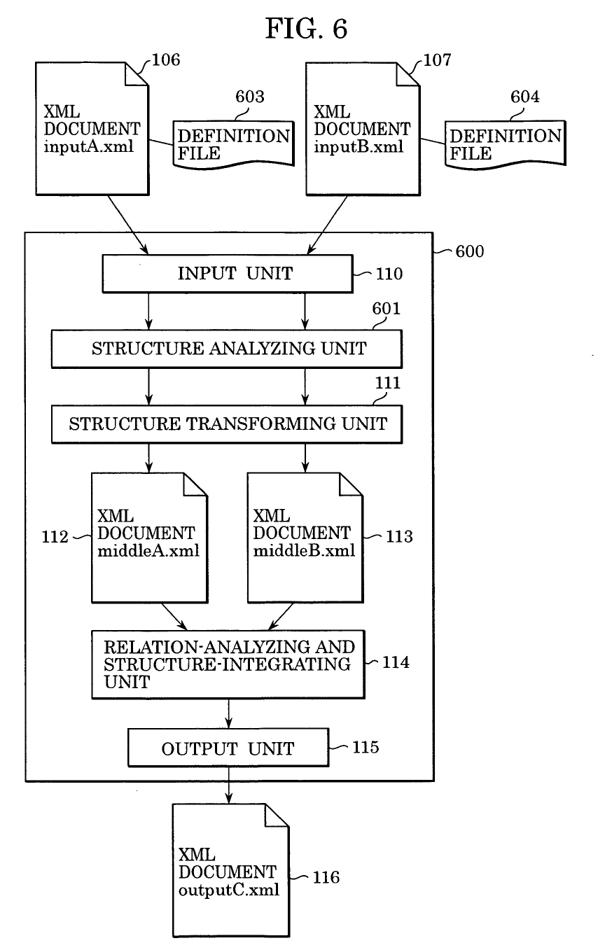

FIG. 6 shows an apparatus 600 for integrating documents, the apparatus 600 being capable of creating lists like the lists 108 and 109 shown in FIG. 1. The flow of processing in the apparatus 600 according to this embodiment is described below with reference to FIG. 6. The apparatus 600 is the structure, in which a structure analyzing unit 601 is added to the apparatus 100 shown in FIG. 1. The structure analyzing unit 601 refers to input definition files and input XML documents, logically analyzes the structure of each input XML document using a simple application program interface (API) for XML (SAX) engine, and extracts data indicating relation. The other structures are the same as the apparatus 100 shown in FIG. 1, and the explanation thereof is omitted.

The processing performed by the apparatus 600 according to this embodiment is described next.

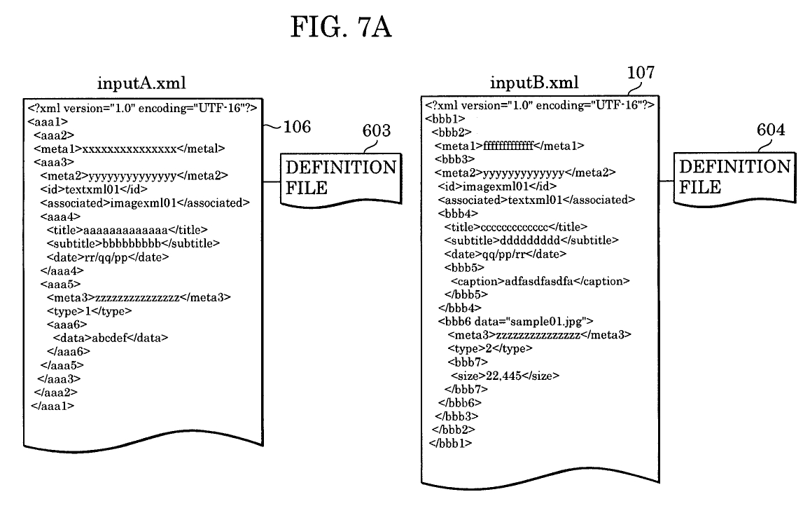

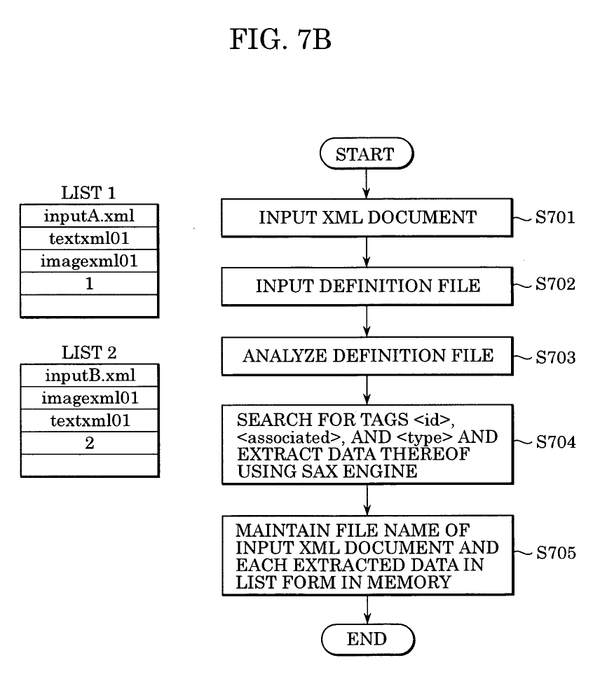

FIG. 7A shows details of the processing for the XML documents in the structure analyzing unit 601 shown in FIG. 6. In this embodiment, the details of the processing are described below with reference to the XML documents 106 and 107 and definition files 603 and 604. FIG. 7B is a flowchart of the processing in the structure analyzing unit 601.

In step S701 (of FIG. 7B), the XML documents 106 and 107 are input, and in step S702, the definition files 603 and 604 are input. The definition files 603 and 604 correspond to the XML documents 106 and 107, respectively, and describe information regarding the uses (e.g., printing), a necessary tag required for the uses, a tag structure up to the necessary tag, a file name, and the like.

In step S703, the structure analyzing unit 601 refers to the definition file 603 and the XML document 106 and automatically analyzes information required for the next process. Examples of information retrieved from the analysis of the definition files 603 and 604 include the processing saying that “extract data of tags <id>, <associated>, and <type>”.

In step S704, the structure analyzing unit 601 sequentially locates tags <id>, <associated>, and <type> in an upper portion of the XML documents using the SAX engine included in the structure analyzing unit 601 and extracts data thereof. The processing then moves to step S705.

In step S705, each extracted data indicating relation with respect to tags in the structured document and information surrounded by the tags is associated with a file name of the input XML document. This associated data is formed into a list, as shown in FIG. 7B, and the list is maintained in a memory. The list contains a file name as the first item and further contains an ID, an ID for a relevant file, and a type number in this order. The lists shown in FIG. 7B have the same structure as the lists 108 and 109 shown in FIG. 1.

The other processes are the same as those in the first embodiment, and the explanation thereof is not repeated here.

Hardware Configuration

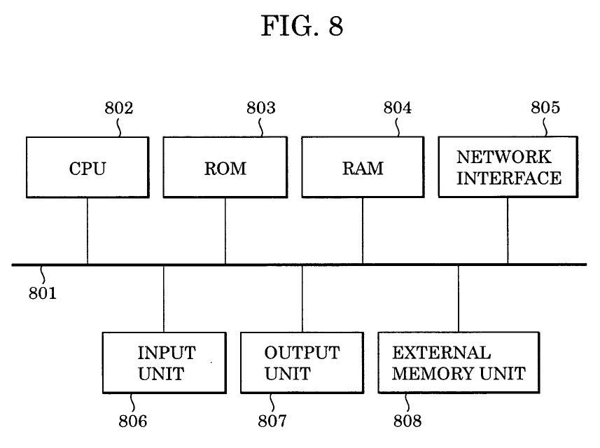

FIG. 8 shows a hardware configuration in the apparatuses 100 and 600.

A bus 801 is connected to a central processing unit (CPU) 802, a read-only memory (ROM) 803, a random-access memory (RAM) 804, a network interface 805, an input unit 806, an output unit 807, and an external memory unit 808.

The CPU 802 performs data processing and computing and controls each component that is connected to the bus 801 via the bus 801. The ROM 803 retains a control procedure (computer program), which is stored in advance, of the CPU 802. This computer program is executed by the CPU 802, so that the apparatus is activated. The external memory unit 808 retains a computer program, and the computer program is copied to the RAM 804 and then executed.

The RAM 804 functions as a working memory for data communications and a temporary storage for controlling each component. The external memory unit 808 is, for example, a hard disk, a CD-ROM, or the like, and is capable of retaining its contents after the power supply is switched off. The CPU 802 performs the processing described above by executing the computer program in the RAM 804.

The network interface 805 is a communication interface for connecting with the Internet, Bluetooth, or the like. The input unit 806 is, for example, a keyboard or a mouse, and various specifications and input can be entered by means of the input unit 806. The output unit 807 is a display or the like.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application Nos. 2004-074812 filed Mar. 16, 2004 and 2005-051777 filed Feb. 25, 2005, which are hereby incorporated by reference herein.

1. An apparatus for integrating documents, the apparatus comprising:
an input device for inputting a plurality of structured documents;
a control device for determining whether relation between the structured documents exists by comparing at least one predetermined element of each of the structured documents between the structured documents and for extracting a description of each element in the structured documents that are determined to have relation therebetween; and
an output device for outputting an integrated structured document realized by integration of each description extracted by the control device from the structured documents determined to have relation therebetween.

2. The apparatus according to claim 1, wherein the control device determines whether relation between the structured documents exists by referring to lists in which character strings described in the structured documents are classified into items, the lists being individually associated with the structured documents.

3. The apparatus according to claim 2, wherein the control device describes an attribute flag for each list corresponding to the structured documents determined to have relation therebetween if the control device determines that relation therebetween exists.

4. The apparatus according to claim 1, wherein the control device deletes an unnecessary element from the structured documents before extracting a description of the each element in the structured documents that are determined to have relation therebetween.

5. A method for integrating documents, the method comprising:
an inputting step of inputting a plurality of structured documents;
a determining step of determining whether relation between the structured documents exists by comparing at least one predetermined element of each of the structured documents between the structured documents;
an extracting step of extracting a description of each element in the structured documents that are determined to have relation therebetween if relation therebetween is determined to exist; and
an outputting step of outputting an integrated structured document realized by integration of each description extracted from the structured documents determined to have relation therebetween.

6. The method according to claim 5, wherein the determining step determines whether relation between the structured documents exists by referring to lists in which character strings described in the structured documents are classified into items, the lists being individually associated with the structured documents.

7. The method according to claim 6, wherein the determining step describes an attribute flag for each list corresponding to the structured documents determined to have relation therebetween if relation therebetween is determined to exist.

8. The method according to claim 5, wherein the extracting step deletes an unnecessary element from the structured documents before extracting a description of the each element in the structured documents that are determined to have relation therebetween.

9. A program for integrating documents, the program performing a method comprising:
an inputting step of inputting a plurality of structured documents;
a determining step of determining whether relation between the structured documents exists by comparing at least one predetermined element of each of the structured documents between the structured documents;
an extracting step of extracting a description of each element in the structured documents that are determined to have relation therebetween if relation therebetween is determined to exist; and
an outputting step of outputting an integrated structured document realized by integration of each description extracted from the structured documents determined to have relation therebetween.

10. The program according to claim 9, wherein the determining step determines whether relation between the structured documents exists by referring to lists in which character strings described in the structured documents are classified into items, the lists being individually associated with the structured documents.

11. The program according to claim 10, wherein the determining step describes an attribute flag for each list corresponding to the structured documents determined to have relation therebetween if relation therebetween is determined to exist.

12. The program according to claim 9, wherein the extracting step deletes an unnecessary element from the structured documents before extracting a description of the each element in the structured documents that are determined to have relation therebetween.
